(19) United States
(12) Patent Application Publication
(10) Pub. No.: US 2026/0118563 A1
(43) Pub. Date: Apr. 30, 2026

(54) PRISM ARRAY PANEL CAPABLE OF HOMOAXIAL IMAGING

(71) Applicant: Shi-Hwa Huang, New Taipei City (TW)

(72) Inventor: Shi-Hwa Huang, New Taipei City (TW)

(21) Appl. No.: 18/931,039

(22) Filed: Oct. 30, 2024

(51) Int. Cl. G02B 5/04; G02B 30/56; G02B 30/60

(52) U.S. Cl. CPC G02B 5/045; G02B 30/56; G02B 30/60

(57) ABSTRACT

The present invention relates to a micro dual orthogonal right angle prism array panel capable of homoaxial imaging. By orthogonally arranging two right angle prisms, the incident light and the outgoing light are aligned in the same axial direction, allowing an object to be imaged at a certain distance from the prism array panel, thus forming a floating image. The present invention has characteristics of short-distance imaging with no image distortion, significantly reducing the size of projection devices. Moreover, the present invention can be configured with a flat panel display; by moving it reciprocally and displaying sectional images of an three-dimensional object during moving, a floating volumetric projection image in midair can be formed and thus create a three-dimensional projection.

### BACKGROUND OF THE INVENTION

### 1. Field of the Invention

The present invention relates to a micro right angle prism array panel, particularly an orthogonal dual right angle prism array panel capable of homoaxial imaging.

### 2. The Prior Arts

To achieve floating imaging, scientists have long been dedicated to developing glasses-free three-dimensional projectors to enhance the effects of flat panel displays and make images appear three-dimensional. So far, the dihedral corner reflector array (hereinafter referred to as DCRA) has been considered a practical example. However, the current DCRA can only present a floating planar image, having a larger device, lower light efficiency, and appearance of ghosting.

The currently known types of DCRA mainly include the perforated DCRA 110 shown in FIG. 1A, the louver-style DCRA 120 shown in FIG. 1B, and the rectangular pillar DCRA 130 shown in FIG. 1C.

The projection principles of the three types of DCRA mentioned above are similar. The light beam originating from the object side (or a flat panel display) enters the DCRA, through two total internal reflections, which can then emerge a light beam at an angle symmetrical to the incident light and form an image on the image side—for example, referring to FIGS. 1C, 2A, and 2B, the rectangular pillar DCRA 130 comprises multiple rectangular prisms 100 arranged in an array. When an incident light beam 101 is emitted from object O and enters the rectangular prism 100 from the F1 surface, it may refract as the first refracted light beam 102. The first refracted light beam 102 is directed to the F2 surface and reflects as the first reflected light beam 103, which is then directed to the F3 surface and reflects as the second reflected light beam 104. The second reflected light beam 104 emerges through the T surface as the outgoing light beam 105, presenting an image at I. Referring to FIG. 2B, when multiple rectangular prisms 100 are arranged in an array, for example, the light beams emitted from a flat panel display 200 are reflected by the rectangular pillar DCRA 130 and then form a real image 400 at a position symmetrical to the reflected right angle. Since the viewing angle between the imaging of real image 400 and observer E is indirect, the real image 400 projected from the flat panel display 200 appears to float in midair as a planar image. In addition, the real image 400 is perpendicular to the flat panel display 200.

The light vector and object-image relationship of the conventional DCRA mentioned may refer to FIG. 2A and be illustrated. The rectangular pillar DCRA 130 is positioned on the plane of y=0 in the coordinate system. Assumed the coordinates of object O are (0, −y₀, y₀); when the incident light beam 101 enters the rectangular pillar DCRA 130, the outgoing light beam 105 has a vector inversed of the incident light beam 101 in the X and Z directions, which means that the incident light 101 and the outgoing light beam 105 are completely symmetrical relative to the plane configuring of the rectangular pillar DCRA 130, and the image forms at I with the coordinates (0, y₀, y₀). By taking the dot product of the normal vectors of the object plane and the image plane, the angular relationship between the two planes can be derived, confirming that the object plane and the image plane are orthogonal. Therefore, the conventional projection device for floating imaging should have a space for the object plane and the image plane to be perpendicular, so it is always larger.

The rectangular prism surfaces are essentially configured by 45 degrees rotated of square pillar, and the reflective surfaces should be coated to allow the incident light to undergo dual reflections. Additionally, to prevent stray light from entering other areas, black paint is applied in the gaps between the prisms to block the light from its dispersion onto the imaging surface. However, such configurations have low light efficiency, reducing it to about 35% or less. Moreover, when the angle of the light source (incident light) is greater than 40 degrees relative to the incident surface, noticeable ghosting issues may arise. Furthermore, as shown in FIG. 3, the total viewing angle perceived by observer E is relatively narrow, around 40 degrees, so that the view field of the imaging is limited.

### SUMMARY OF THE INVENTION

Given the problems mentioned above, one of the objectives of the embodiments of the present disclosure is to provide a prism array panel capable of homoaxial imaging so that the size of the projection device can be decreased. To achieve the above object, an embodiment of the present disclosure provides a prism array panel comprising a plurality of first units, each with a first prism and a second prism. The first prism includes a first incident surface, a first incident reflective surface, a first outgoing reflective surface, and a first exiting surface, wherein the first incident reflective surface and the first outgoing reflective surface are adjacent to each other to form a first right angle, while the first incident surface and the first exiting surface are formed on the opposite sides of the first right angle. The second prism includes a second incident surface, a second incident reflective surface, a second outgoing reflective surface, and a second exiting surface, wherein the second incident reflective surface and the second outgoing reflective surface are adjacent to each other to form a second right angle, while the second incident surface and the second exiting surface are formed on the opposite sides of the second right angle. The first prism and the second prism are connected orthogonally, with the first exiting surface corresponding to the second incident surface. When an incident light beam enters from the first incident surface, it can emit homoaxially from the second exiting surface. The plurality of the first units is then arranged in an array with intervals or adjacent to form the prism array panel.

In an example of the present disclosure, the upper and lower sides of the prism array panel may be further covered respectively by an upper light-blocking plate and a lower light-blocking plate, wherein the upper light-blocking plate covers the areas other than that of the vertical projection of the second exiting surfaces, and the lower light-blocking plate covers the areas other than that of the vertical projection of the first incident surfaces.

In an example of the present disclosure, the refractive index of the first prism and the second prism may be greater than \sqrt{2}.

In an example of the present disclosure, the first right angle and the second right angle are isosceles right angles. Assumed that the long-side length of the first incident reflective surface and the second incident reflective surface is h, the short-side length thereof is w, and the base length of the first incident surface added with the first exiting surface, or of the second incident surface added with the second exiting surface is d, and d.h:w=2:\sqrt{2}:1.

In another example of the present disclosure, the prism array panel may further comprise a plurality of second units, each with a third prism and a fourth prism. The third prism includes a third incident surface, a third incident reflective surface, a third outgoing reflective surface, and a third exiting surface, wherein the third incident reflective surface and the third outgoing reflective surface are adjacent to each other to form a third right angle, while the third incident surface and the third exiting surface are formed on the opposite sides of the third right angle. The fourth prism includes a fourth incident surface, a fourth incident reflective surface, a fourth outgoing reflective surface, and a fourth exiting surface, wherein the fourth incident reflective surface and the fourth outgoing reflective surface are adjacent to each other to form a fourth right angle, while the fourth incident surface and the fourth exiting surface are formed on the opposite sides of the fourth right angle. The third prism and the fourth prism are connected orthogonally, with the third exiting surface corresponding to the fourth incident surface; and when an incident light enters through the third incident surface, it can emit homoaxially from the fourth exiting surface. Each of the second units has the same structure as the first unit, and each of the second units is coupled with each of the first units being rotated 180 degrees horizontally to form a prism module; the plurality of the prism modules is then arranged in an array with intervals or adjacent to form the panel.

In an example of the present disclosure, the upper and lower sides of the prism array panel may further be covered respectively by an upper light-blocking plate and a lower light-blocking plate, wherein the upper light-blocking plate covers the areas other than that of the vertical projection of the second exiting surfaces and fourth exiting surfaces, while the lower light-blocking plate covers the areas other than that of the vertical projection of the first incident surfaces and third incident surfaces.

In one aspect of the embodiment, the refractive index of the third prism and the fourth prism may be greater than \sqrt{2}.

In an example of the present disclosure, the third right angle and the fourth right angle are isosceles right angles. Assumed that the long-side length of the third incident reflective surface and the fourth incident reflective surface is h, the short-side length thereof is w, and the base length of the third incident surface added with the third exiting surface, or of the fourth incident surface added with the fourth exiting surface is d, and d:h:w=2:\sqrt{2}:1.

In yet another example of the present disclosure, a flat panel display may further be configured below the prism array panel, and thus, an image displayed from the flat display can form a homoaxial floating image on the opposite side of the prism array panel.

In one aspect of the embodiment, the flat panel display is capable of reciprocal moving along the imaging axis and displaying sectional images of a three-dimensional object during moving, thus forming a volumetric projection image in midair and creating a three-dimensional floating projection.

By employing the present disclosure, the conventional DCRA imaging device with a right angle projection is transformed into a homoaxial imaging system, significantly decreasing the volume of the projection device. Furthermore, when the present disclosure is combined with a flat panel display, a thin floating projection device is obtained, moreover, through the reciprocal moving of the flat panel display, a floating three-dimensional projection can also be presented.

### BRIEF DESCRIPTION OF THE DRAWINGS

Disclosed herein will be apparent to those skilled in the art by reading the following detailed description of a preferred embodiment thereof, with reference to the attached drawings, in which:

FIG. 1A is a schematic diagram showing a conventional perforated DCRA;

FIG. 1B is a schematic diagram showing a conventional louver-type DCRA;

FIG. 1C is a schematic diagram showing a conventional rectangular pillar DCRA;

FIG. 2A is a schematic diagram showing an optical path of the conventional rectangular pillar DCRA of FIG. 1C;

FIG. 2B shows the object-image relationship and optical path of the conventional rectangular pillar DCRA of FIG. 1C;

FIG. 3 shows the viewing angle of the rectangular pillar DCRA of FIG. 1C;

FIG. 4 is a exploded diagram showing the first unit according to an embodiment of the present invention;

FIGS. 5A and 5B are assembly and perspective diagrams of the first unit of FIG. 4;

FIG. 6 shows the optical path in the first unit according to an embodiment of the present invention;

FIG. 7 shows the array formation of the first unit according to an embodiment of the present invention;

FIG. 8 is a schematic diagram showing the optical path for imaging according to an embodiment of the present invention;

FIG. 9A is a schematic diagram showing the first unit according to another embodiment of the present invention;

FIG. 9B shows the array formation of the first unit of FIG. 9A;

FIGS. 10A and 10B show the optical path and structural diagram of the first prism according to an embodiment of the present invention;

FIG. 11 is a schematic diagram showing the first and second units according to an embodiment of the present invention;

FIG. 12A shows the assembly diagram of the first and second units shown in FIG. 11;

FIGS. 12B and 12C are the top and bottom views of the assembly diagram of FIG. 12A;

FIG. 13A shows a three-dimensional view of FIG. 11 from another view angle and a schematic diagram configured with the upper and lower light-blocking plates;

FIG. 13B shows an upward three-dimensional view of FIG. 11 and a schematic diagram configured with the upper and lower light-blocking plates;

FIG. 14 is a schematic diagram showing the application of the prism array panel for floating imaging an; and

FIGS. 15A and 15B are schematic diagrams showing the application of the prism array panel for three-dimensional projection according to yet an embodiment of the present invention.

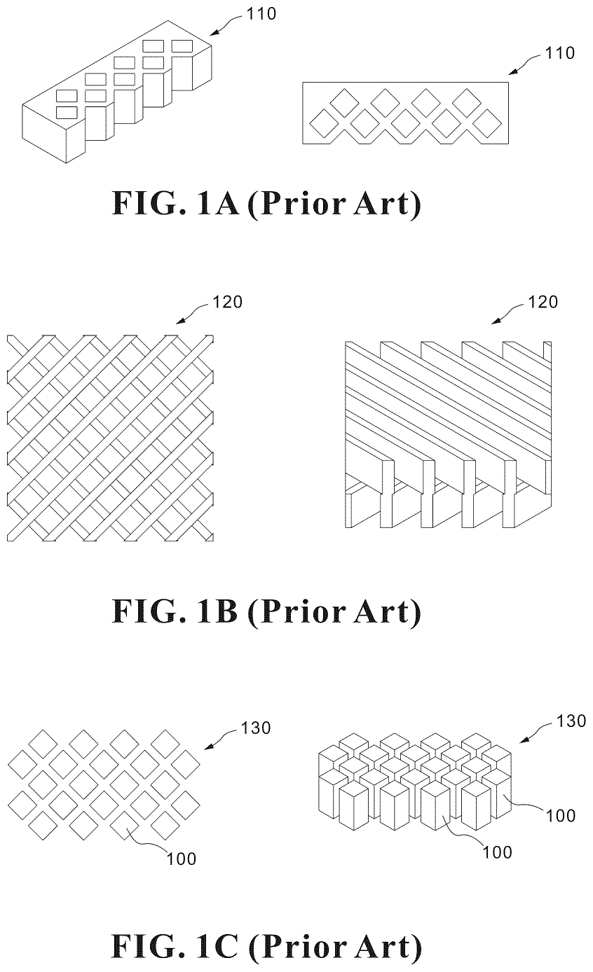

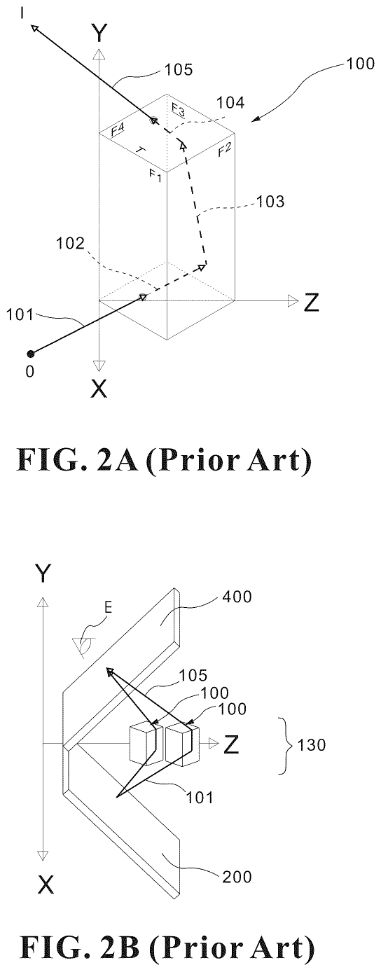

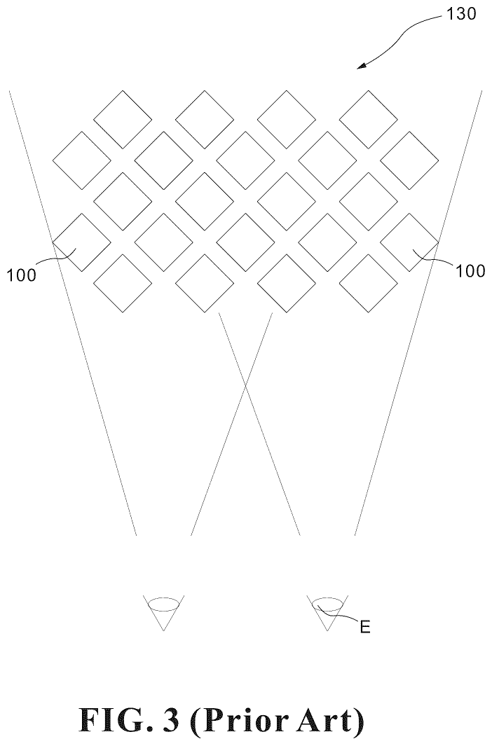

### DETAILED DESCRIPTION OF THE PREFERRED EMBODIMENT

The following description and examples illustrate a preferred embodiment of the present invention in detail. They are used to describe the present invention, not to limit the scope of the present invention.

The “homoaxial” described herein refers to that light beams are parallel and directed in the same direction, such that “homoaxial imaging” refers that an emitting light beam from an object will form an image at a position with a light axial parallel to that of the emitting light beam.

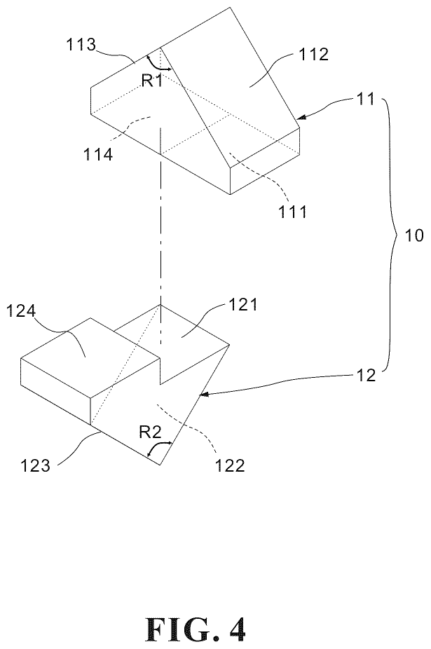

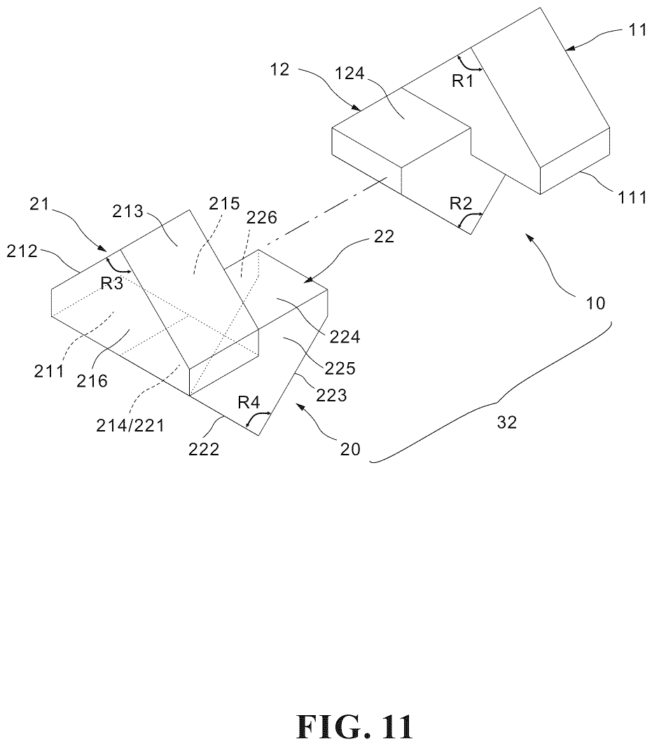

The homoaxial imaging prism array panel according to an embodiment of the present invention may include a first unit 10 shown in FIG. 4 or a prism module 32 comprising the first unit 10 and the second unit 20 shown in FIG. 11. The structures of the first unit 10 and the second unit 20 are identical, either rotated horizontally by 180 degrees and disposed adjacently to each other so that the prism module 32 can be obtained.

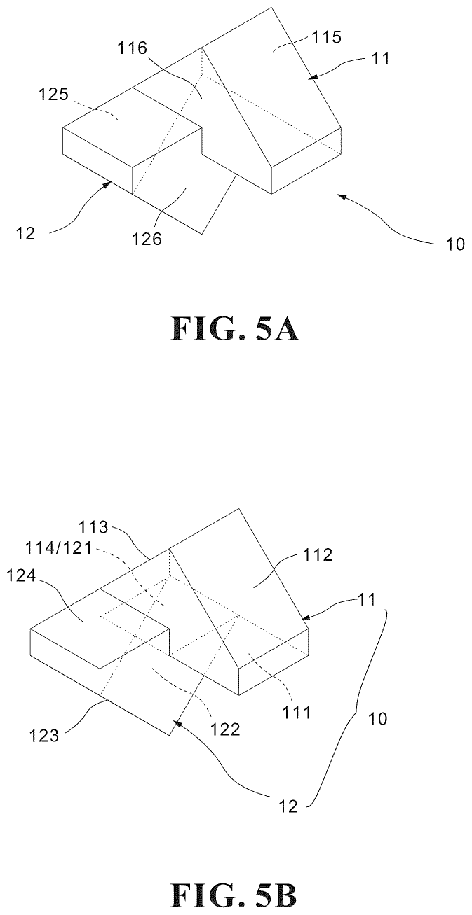

Firstly, referring to FIGS. 4, 5A, and 5B, in this embodiment, the first unit 10 comprises a first prism 11 and a second prism 12, which are connected in orthogonal directions. The first prism 11 includes a first incident surface 111, a first incident reflective surface 112, a first outgoing reflective surface 113, and a first exiting surface 114. The first incident reflective surface 112 and the first outgoing reflective surface 113 are adjacent to form a first right angle R1. The first incident surface 111 and the first exiting surface 114 are on opposite sides of the first right angle R1. The second prism 12 includes a second incident surface 121, a second incident reflective surface 122, a second outgoing reflective surface 123, and a second exiting surface 124. The second incident reflective surface 122 and the second outgoing reflective surface 123 are adjacent to form a second right angle R2. The second incident surface 121 and the second exiting surface 124 are on opposite sides of the second right angle R2. The second incident surface 121 and the second exiting surface 124 can be arranged in the same plane or, as illustrated, in different but parallel planes.

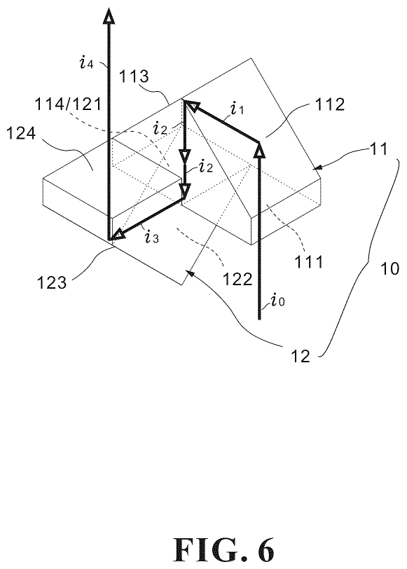

Referring again to FIGS. 5A and 5B, the first prism 11 and the second prism 12 are arranged in orthogonal directions; in this embodiment, the first exiting surface 114 corresponds to and is connected to the second incident surface 121. Now refer to FIG. 6, which illustrates the optical path passing through the first unit 10. The incident light beam i₀ firstly vertically enters the first prism 11 from the first incident surface 111 of the first unit 10. By the first incident reflective surface 112, incident light beam i₀ is reflected as light beam i₁ and directed to the first outgoing reflective surface 113 and reflected as light beam i₂. The light beam i₂ finally exits the first prism 11 from the first exiting surface 114 and directly enters the second prism 12 via the second incident surface 121. Within the second prism 12, the light beam i₂ is reflected as light beam i₃ from the second incident reflective surface 122, and the light beam i₃ is directed to the second outgoing reflective surface 123 and reflected as light beam i₄, which finally exits the second prism 12 from the second exiting surface 124. The incident light beam i₀ and the outgoing light beam i₄ are aligned in the same axial direction, allowing the focus of the outgoing light beam i₄ to be reversed and creating an inverted image formed on the opposite side of the first unit 10.

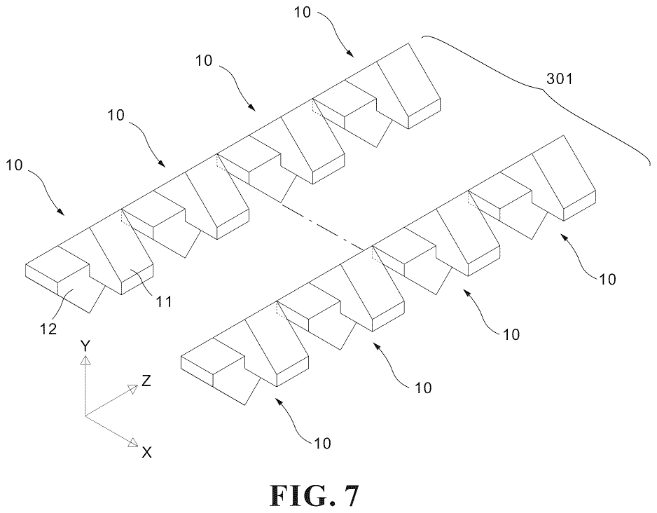

Referring to FIG. 7, a plurality of the first unit 10 is arranged in an array to form the prism array panel 301. The first units 10 can be disposed adjacent to each other or, as in this embodiment, spaced apart by a certain distance in either the Z or/and X axes. This arrangement allows for adequate light management and enhances the overall optical performance of the prism array panel 301. Each of the first unit 10 contributes to the homoaxial imaging panel, ensuring that light enters from the designated incident surfaces and is efficiently redirected and focused to present the desired imaging.

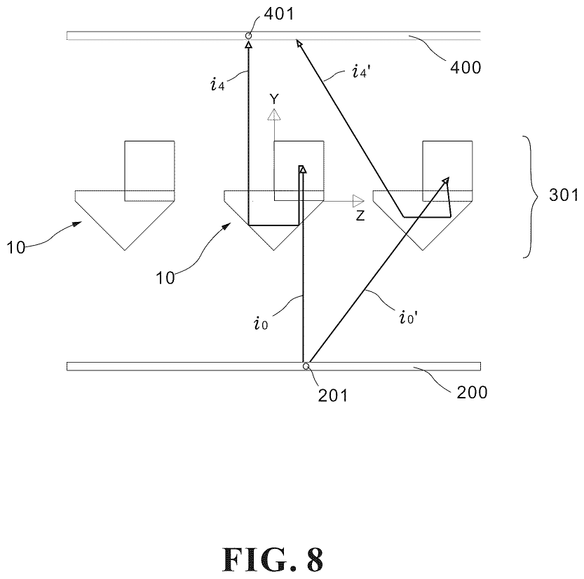

FIG. 8 is a schematic diagram of the optical path of the homoaxial imaging prism array panel of FIG. 7. The relationship between object and image based on linear algebra will be described by taking FIGS. 6 and 8 as examples. As shown in FIG. 8, the prism array panel 301 is positioned on the plane y=0. The normal vectors of the first incident reflective surface 112 and the first outgoing reflective surface 113 of the first prism 11 are n₁₁₂ and n₁₁₃, respectively, wherein n₁₁₂=1/\sqrt{2} (1, −1, 0) and n₁₁₃=1/\sqrt{2} (−1, −1, 0). Similarly, the normal vectors of the second incident reflective surface 122 and the second outgoing reflective surface 123 of the second prism 12 are n₁₂₂ and n₁₂₃, respectively, wherein n₁₂₂=1/\sqrt{2} (0, 1, −1) and n₁₂₃=1/\sqrt{2} (0, 1, 1).

Assumed that an object 201 is positioned on some point of the display 200, i.e., the object 201 is on the plane y+y₀=0. Let the coordinates of the object 201 be (x₀,−y, z₀), and the light vector of the incident light beam i₀ will be (l, m, n), wherein l=cos(±Δθₓ), m=cos θ_{y}, and n=cos(±Δθ_{z}). Since θ_{y}=0 in this embodiment, m=1, the light vector of the incident light beam i₀ will be (l, 1, n).

Then, the incident light i₀ will undergo reflection through the first prism 11 and the second prism 12, resulting in four vector transformations. According to linear algebra principles, the light beam i₁ reflected from the first incident reflective surface 112 has the vector as follows:

$${i}_{1} = {i}_{0} - 2 ( {i}_{0} \cdot {n}_{112} ) {n}_{112} = ( l , 1 , n ) - 2 \frac{1}{\sqrt{2}} ( l - 1 ) \frac{1}{\sqrt{2}} ( 1 , - 1 , 0 ) = ( 1 , l , n ) . \qquad ( 1 )$$

The light beam i₂ reflected from the first outgoing reflective surface 113 has the vector as follows:

$${i}_{2} = {i}_{1} - 2 ( {i}_{1} \cdot {n}_{113} ) {n}_{113} = ( 1 , l , n ) - 2 \frac{1}{\sqrt{2}} ( - 1 - l ) \frac{1}{\sqrt{2}} ( - 1 , - 1 , 0 ) = ( - l , - 1 , n ) . \qquad ( 2 )$$

The light beam i₃ reflected from the second incident reflective surface 122 has the vector as follows

$${i}_{3} = {i}_{2} - 2 ( {i}_{2} \cdot {n}_{122} ) {n}_{122} = ( - l , - 1 , n ) - 2 \frac{1}{\sqrt{2}} ( - 1 - n ) \frac{1}{\sqrt{2}} ( 0 , 1 , - 1 ) = ( - l , n , - 1 ) . \qquad ( 3 )$$

The light beam i₄ reflected from the second outgoing reflective surface 123 has the vector as follows:

$${i}_{4} = {i}_{3} - 2 ( {i}_{3} \cdot {n}_{123} ) {n}_{123} = ( - l , n , - 1 ) - 2 \frac{1}{\sqrt{2}} ( n - 1 ) \frac{1}{\sqrt{2}} ( 0 , 1 , 1 ) = ( - l , 1 , - n ) . \qquad ( 4 )$$

From the above description, it is clear that the vector i₄ corresponds to the vector i₀ with a reversal of directions along the X and Z axes. Furthermore, compared to the y=0 plane of the prism array panel 301, the vector i₄ is entirely symmetrical to the vector i₀.

Finally, the point of imaging 401 possesses coordinates (x₀, y₀, z₀), and the imaging plane 400 is on the plane of y−y₀=0. Based on the above description, the prism array panel 301 essentially provides a solution to the vector, (l, 1, n), of the incident light i₀, wherein l=cos(±Δθₓ), and n=cos(=Δθ_{z}). Such reveals that the relationship between the object and the imaging is homoaxial and flattened, thus enabling slim down the projection device.

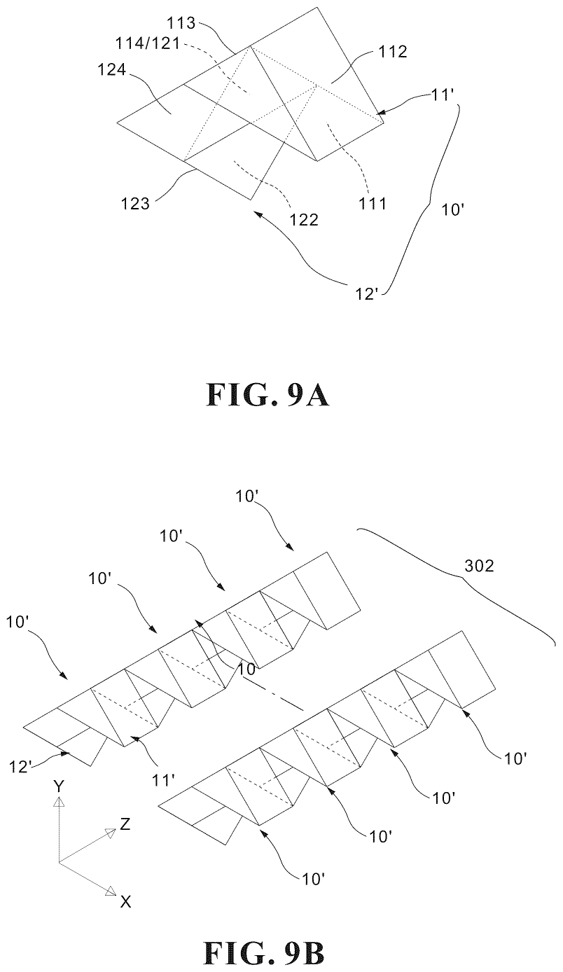

Referring to both FIGS. 9A and 9B, which show a three-dimensional view of another embodiment regarding the first unit of the prism array panel. In this embodiment, a first unit 10′ is provided. The first unit 10′ includes a first prism 11′ and a second prism 12′, which are right angle prisms without the rectangular prism protruding at the base as described in the previous embodiment. The first prism 11′ and the second prism 12′ are configured in the same manner as mentioned above by orthogonal connection. In this embodiment, a plurality of the first unit 10′ is disposed adjacently to form the prism array panel 302. This embodiment allows for a more compact structure while retaining the homoaxial imaging.

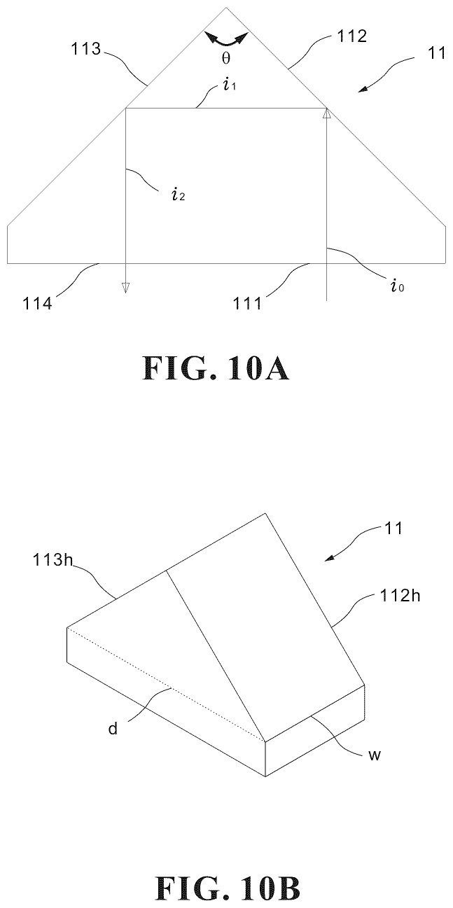

Please refer to FIGS. 10A and 10B, which illustrate the optical path and schematic view of the previously described first prism 11. The structure of the second prism 12, third prism 13, and fourth prism 14 are identical to the first prism 11. In this embodiment, the incident light beam i₀ enters vertically from the first incident surface 111, then reflected as light beam i₁ by the first incident reflecting surface 112, and subsequently reflected as light beam i₂ by the first exiting reflecting surface 113. According to Snell's Law, the equation as n sin θ>1 must be satisfied, wherein n is the refractive index of the prism. Since θ=π/4, this leads to n>\sqrt{2}.

On the other hand, taking still the first prism 11 as an example, if we define the lengths of the long side of the first incident reflecting surface 112 or the first exiting reflecting surface 113 as h, the short side thereof as w, and the opposite side width corresponding to angle θ as d (which may be the total width of the first incident surface 111 adding the first exiting surface 114), the relationship of which may be, but not limited to, expressed as d:h:w=2:\sqrt{2}:1.

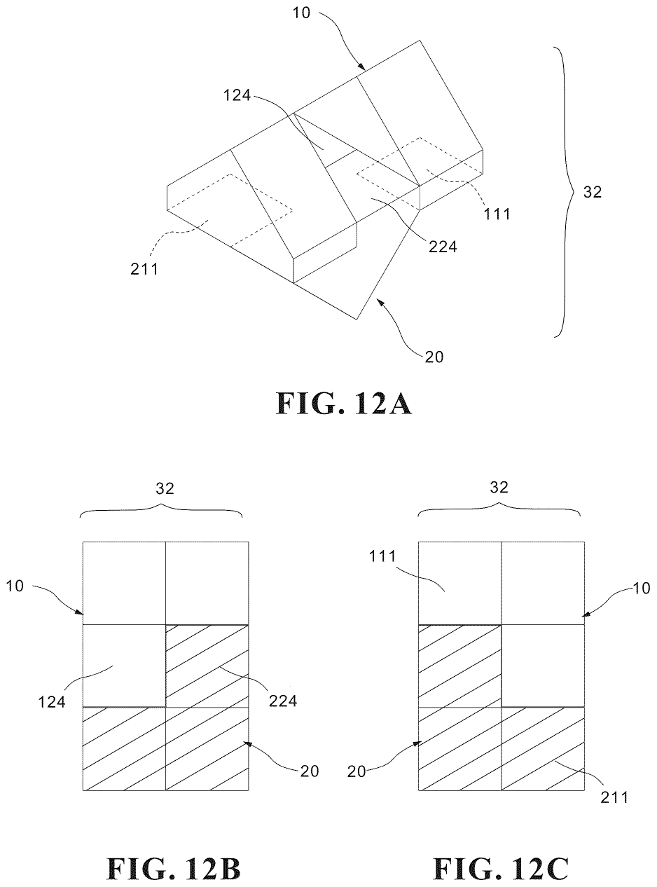

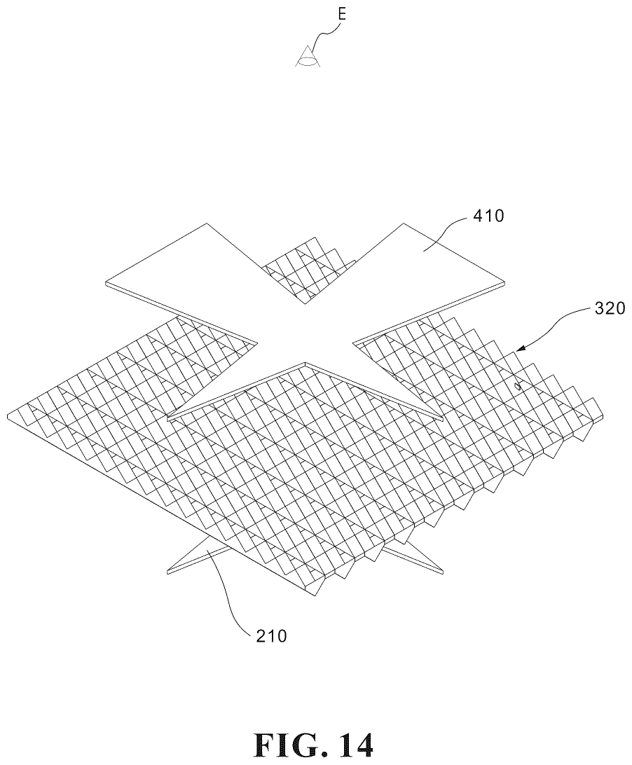

Please refer to both FIG. 11 and FIG. 12A, FIG. 11 illustrates a three-dimensional view of the first and second units according to another embodiment of the prism array panel of the present invention, and FIG. 12A shows the assembly diagram of the first and second units shown in FIG. 11. To further enhance the symmetry of the unit arrangement within the prism array panel, the spatial assembly efficiency, and increasing light quantity, this embodiment provides a second unit 20 in addition to the first unit 10. The second unit 20 has the same structure as the first unit 10 but horizontally rotates 180 degrees relative to the first unit 10 when assembly. As shown in FIG. 12A, the second unit 20 couples with the first unit 10 to form a prism module 32 as a rectangular shape from the top view. Plurals of prism module 32 are then arranged in a spaced or adjacent manner to obtain a planar prism array panel (as prism array panel 320 in FIG. 14.

Referring simultaneously to FIGS. 11, 12A, 12B and 12C, the second unit 20 includes a third prism 21 and a fourth prism 22 in this embodiment. The third prism 21 has a third incident surface 211, a third incident reflective surface 212, a third outgoing reflective surface 213, and a third exiting surface 214. The third incident reflective surface 212 and the third outgoing reflective surface 213 are adjacent to form a third right angle R3, while the third incident surface 211 and the third exiting surface 214 are on opposite sides of the third right angle R3. Similarly, the fourth prism 22 has a fourth incident surface 221, a fourth incident reflective surface 222, a fourth outgoing reflective surface 223, and a fourth exiting surface 224. The fourth incident reflective surface 222 and the fourth outgoing reflective surface 224 are adjacent to form a fourth right angle R4, while the fourth incident surface 221 and the fourth exiting surface 224 are on opposite sides of the fourth right angle R4. The third prism 21 and the fourth prism 22 are also assembled in orthogonal directions, with the third exiting surface 214 corresponding to and being connected to the fourth incident surface 221. When an incident light beam enters through the third incident surface 211, it can exit from the fourth exiting surface 224, maintaining a homoaxial output.

Referring continually to FIGS. 12A, 12B, and 12C, FIGS. 12B and 12C are the top and bottom views of the prism module 32 shown in FIG. 12A, respectively. From the bottom view, it can be seen that if the light source comes from below the prism module 32, the light beams emitted can enter from the first incident surface 111 and the third incident surface 211. Then, as observed from the top view, the incident light beams ultimately exit the prism module 32 from the second exiting surface 124 and the fourth exiting surface 224.

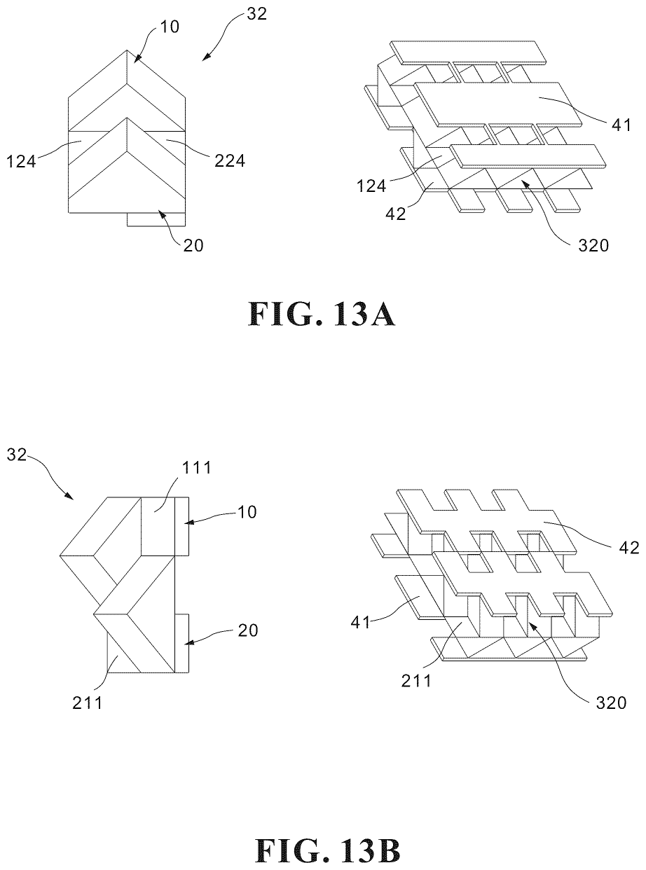

Please refer to FIGS. 13A and 13B, which show a three-dimensional view of FIG. 11 from another view angle, along with a top schematic view after configuring an upper light-blocking plate and a lower light-blocking plate. In this embodiment, to avoid stray light affecting the clarity of the imaging, an upper light-blocking plate 41 and a lower light-blocking plate 42 can be further disposed above and below the prism array panel 320 assembled from the prism modules 32. The upper light-blocking plate 41 is available to cover the areas other than that of the vertical projection of the second exiting surface 124 and the fourth exiting surface 224. In contrast, the lower light-blocking plate 42 is available to cover the areas other than that of the vertical projection of the first incident surface 111 and the third incident surface 211.

Please refer to FIG. 14, which is a schematic diagram showing floating imaging of the prism array panel according to an embodiment of the present invention. In this embodiment, the prism modules 32 are arranged adjacently to form a prism array panel 320. An object 210 on one side of the prism array panel 320 can be imaged at a symmetrical position on the opposite side of the prism array panel 320, allowing the observer E to see the image 410 appearing to float in midair.

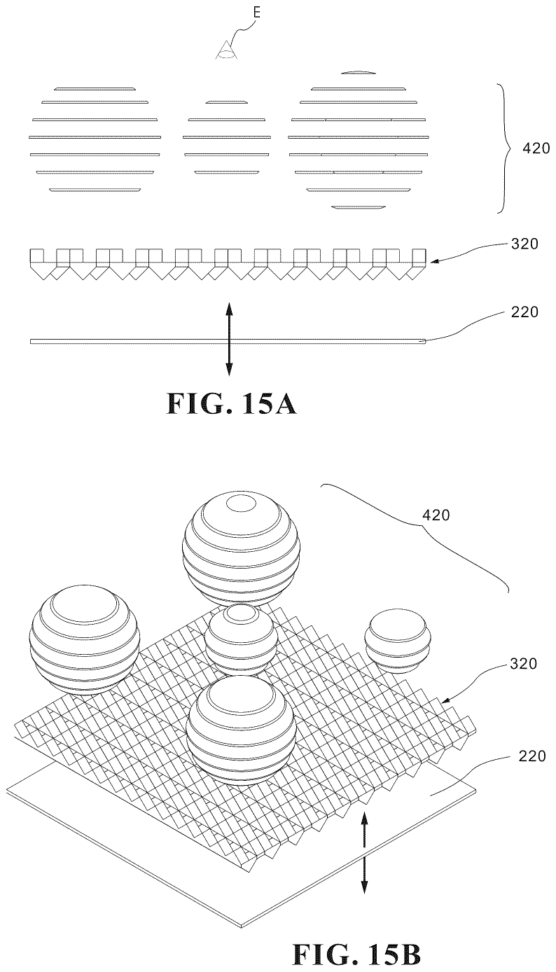

Referring to FIGS. 15A and 15B simultaneously, which show schematic diagrams for three-dimensional projection of the prism array panel according to yet another embodiment of the present invention. In this embodiment, the plurality of the prism units 32 are also arranged adjacently to form a prism array panel 320. A flat display 220 is set up on one side of the prism array panel 320. When the flat display 220 is stationary, a floating but flat image, as well as that in FIG. 14, is present or projected. However, if the flat display 220 moves reciprocally relative to the prism array panel 320 while simultaneously displaying sectional images of a three-dimensional object during moving, a three-dimensional spatial distribution of sectional images can be presented at a symmetrical position on the opposite side of the prism array panel 320. Due to visual persistence, observer E will see a three-dimensional image 420 appearing to float in midair, thereby achieving the purpose of three-dimensional projection.

In an embodiment of the present invention, the first prism 11, the second prism 12, the third prism 21, and the fourth prism 22 may be, but not limited to, right angle prisms, which may have a protruding rectangular prism at the base. The materials for the prisms may be, but not limited to, acrylic (PMMA) or glass. Additionally, to enhance image clarity and avoid stray light, the side surfaces of the right angle prisms specifically, the first incident reflective surface 112, the first outgoing reflective surface 113, the second incident reflective surface 122, the second exiting reflecting surface 123, as well as the third incident reflecting surface 212, the third outgoing reflective surface 213, the fourth incident reflecting surface 222, and the fourth outgoing reflective surface 223—can be coated with a membrane for total reflection to increase light reflection efficiency. Furthermore, the side surfaces 115, 116, 125, 126, 215, 216, 225, and 226 can be made opaque, such as painted black or covered with opaque sheets.

What is claimed is:

1. A prism array panel capable of homoaxial imaging, comprising:
a plurality of first units, each of the first units having:
a first prism, including a first incident surface, a first incident reflective surface, a first outgoing reflective surface, and a first exiting surface, wherein the first incident reflective surface and the first outgoing reflective surface are adjacent to each other to form a first right angle, while the first incident surface and the first exiting surface are formed on the opposite sides of the first right angle; and
a second prism, including a second incident surface, a second incident reflective surface, a second outgoing reflective surface, and a second exiting surface, wherein the second incident reflective surface and the second outgoing reflective surface are adjacent to each other to form a second right angle, while the second incident surface and the second exiting surface are formed on the opposite sides of the second right angle;
wherein the first prism and the second prism are connected orthogonally, with the first exiting surface corresponding to the second incident surface; and when an incident light enters from the first incident surface, it can emit homoaxially from the second exiting surface; and
the plurality of the first units are arranged in an array with intervals or adjacent to form the prism array panel.

2. The prism array panel according to claim 1, wherein the upper and lower sides of the prism array panel are further covered respectively by an upper light-blocking plate and a lower light-blocking plate, wherein the upper light-blocking plate covers the areas other than that of the vertical projection of the second exiting surfaces, and the lower light-blocking plate covers the areas other than that of the vertical projection of the first incident surfaces.

3. The prism array panel according to claim 1, wherein the refractive index of both the first prism and the second prism is greater than \sqrt{2}.

4. The prism array panel according to claim 1, wherein the first right angle and the second right angle are isosceles right angles, assumed that the long-side length of the first incident reflective surface and the second incident reflective surface is h, the short-side length thereof is w, and the base length of the first incident surface added with the first exiting surface, or of the second incident surface added with the second exiting surface is d, and d:h:w=2:\sqrt{2}:1.

5. The prism array panel according to claim 1, further comprising a plurality of second units, each of the second units having:
a third prism, including a third incident surface, a third incident reflective surface, a third outgoing reflective surface, and a third exiting surface, wherein the third incident reflective surface and the third outgoing reflective surface are adjacent to each other to form a third right angle, while the third incident surface and the third exiting surface are formed on the opposite sides of the third right angle; and
a fourth prism, including a fourth incident surface, a fourth incident reflective surface, a fourth outgoing reflective surface, and a fourth exiting surface, wherein the fourth incident reflective surface and the fourth outgoing reflective surface are adjacent to each other to form a fourth right angle, while the fourth incident surface and the fourth exiting surface are formed on the opposite sides of this fourth right angle;
wherein the third prism and the fourth prism are connected orthogonally, with the third exiting surface corresponding to the fourth incident surface; and when an incident light enters through the third incident surface, it can emit homoaxially from the fourth exiting surface;
wherein each of the second units having the same structure as the first units, and each of the second unit is coupled with each of the first unit being rotated 180 degrees horizontally to form a prism module; and
the plurality of the prism modules is arranged in an array with intervals or adjacent to form the panel.

6. The prism array panel according to claim 5, wherein the upper and lower sides of the prism array panel are further covered respectively by an upper light-blocking plate and a lower light-blocking plate, wherein the upper light-blocking plate covers the areas other than that of the vertical projection of the second exiting surfaces and the fourth exiting surfaces, while the lower light-blocking plate covers the areas other than that of the vertical projection of the first incident surfaces and the third incident surfaces.

7. The prism array panel according to claim 5, wherein the refractive index of both the third prism and the fourth prism is greater than \sqrt{2}.

8. The prism array panel according to claim 5, wherein the third right angle and the fourth right angle are isosceles right angles, assumed that the long-side length of the third incident reflective surface and the fourth incident reflective surface is h, the short-side length thereof is w, and the base length of the third incident surface added with the third exiting surface, or of the fourth incident surface added with the fourth exiting surface is d, and d:h:w=2:\sqrt{2}:1.

9. The prism array panel according to claim 5, wherein a flat panel display is further configured below the prism array panel, and thus an image displayed from the flat panel display can form a homoaxial floating image on the opposite side of the prism array panel.

10. The prism array panel according to claim 9, wherein the flat panel display is capable of reciprocal moving along the imaging axis and displaying sectional images of a three-dimensional object during moving, thus forming a volumetric projection image in midair and creating a three-dimensional floating projection.
